(19) United States
(12) Patent Application Publication
(10) Pub. No.: US 2017/0167433 A1
(43) Pub. Date: Jun. 15, 2017

(54) INSERTS FOR A TWO-STROKE ENGINE

(71) Applicant: CALDWELL RACING TECHNOLOGY, Orange, TX (US)

(72) Inventor: William Matthew Caldwell, Ocean Springs, MS (US)

(21) Appl. No.: 14/964,382

(22) Filed: Dec. 9, 2015

(51) Int. Cl. F02F 1/42; F02F 1/22; F02F 1/00; F02B 75/02

(52) U.S. Cl. CPC F02F 1/42; F02B 75/02; F02F 1/22; F02F 1/004; F02B 2710/03; F02F 2200/00; F02B 2075/025

(57) ABSTRACT

Provided is a modified two-stroke engine with an intake system having a plurality of removable inserts and a cylinder liner for each cylinder bore. The inserts fit within specific cavities in the engine's cylinder bores and are aligned with corresponding intake ports, upper transfer, lower transfer and central boost ports, in each liner. Certain embodiments may include an exhaust insert for the exhaust port. The exhaust insert can be a single piece or a set of three. Also provided is an engine having a billet aluminum block, forged as one piece, cylinder bores, insert cavities, removable intake inserts, pucks to cover the cylinder bores, a cylinder head base with a ring and a cylinder head cap. The ring prevents the separation of liner from water jacket. The power output of the engine is regulated by varying the size of the inserts. Additionally, methods for assembling, tuning and modifying an engine's horsepower are provided.

### BACKGROUND OF THE INVENTION

Field of the Invention

The present invention relates to a two-stroke engine and to an enhanced intake and/or exhaust system that allows for finer tunability, enhanced performance, easier repair and less pollutant emissions. In particular, the present invention relates to removable inserts for the intake and exhaust systems for two-stroke engines.

Description of the Related Art

Two-stroke engines are internal combustion engines that are widely used in various applications including racing boats, lawn and garden equipment, dirt bikes, jet skis and radio-controlled model planes. Such engines complete a power cycle (intake, compression, power, and exhaust) with only two strokes of the piston during a single crankshaft rotation. As such, they have a simpler configuration (e.g. no cylinder valves), are easier to construct (fewer moving parts), have lighter weight, can work in any orientation and produce more power per cubic centimeter of displacement than four-stroke engines.

In its simplest form, a two-stroke engine operates as follows. As the piston rises during the compression phase, partial vacuum is created in the crankcase. An intake port opens, allowing air/fuel mixture to enter the crankcase. As the piston nears Top Dead Center, a spark fires the compressed mixture. The energy resulting from the fuel combustion creates the pressure that drives the piston down the bore, rotating the crankshaft. As the piston moves downwards in the bore, it uncovers an exhaust port in the cylinder wall through which spent fuel is discarded, and concurrently compresses the fuel-air mixture trapped beneath it in the crankcase. As the piston descends more, it exposes transfer ports, which are connected to the crankcase. Gas mixture from the crankcase enters into the cylinder through the transfer ports until the piston is near Bottom Dead Center.

An intake system within a cylinder of a two-stroke engine may contain up to five discrete ports but, not limited to, a central boost port, two finger ports and two transfer ports (also referred to as scavenger ports). There is usually one exhaust port but more is possible. All ports are located on a cylinder sleeve. A six ported cylinder sleeve or liner, therefore, comprises five intake ports and one exhaust port. The finger ports enhance boost activity, and are located below the boost ports.

Tuning a two-stroke engine and adjusting its power output to either provide optimal performance or more horsepower is a tedious undertaking. It involves disassembling the engine, sometimes acid washing the cylinder block along with stripping the plating and replacing the cylinder liner, reassembling the various components and porting. To change its power output, the size of the ports may have to be changed or the cylinder liners may have to be replaced with other liners having different port sizes so as to better regulate the volume of air flow into and out of the cylinder. Accordingly, the tuning cannot be done on site, is time-consuming and expensive.

Currently, building a custom engine with a specific range of power output entails machining an engine block with certain particular specifications for the cylinder cavity and port system to match the output. This means that to change the horsepower of an engine, it would be necessary to change the block or re-machine the cavity and sleeves, a difficult task. Having one generic engine block that can match various cylinder sleeves and energy outputs would significantly reduce the time and cost of building a custom engine.

Another drawback of running two-stroke engines is that they are air-polluting. Typically such engines do not have a pressurized lubrication system, and so oil is added to the air/fuel mixture to lubricate the piston within the cylinder and the roller bearings on the crankshaft. The oil burns when the fuel/air mixture combusts, resulting in polluting emissions. With the continued tightening of emissions regulations, this poses a serious drawback for this type of engines. There is a need for modified two-stroke engines that are easier to tune, cheaper to cast, more efficient to run and produce less polluting emissions.

Embodiments of the present disclosure address the afore-mentioned shortcomings associated with existing conventional two-stroke engines. For example, the current invention provides an enhanced intake and/or exhaust system comprising removable and interchangeable inserts that allows for finer tunability, faster and easier repair, enhanced performance with lower levels of emission control.

### SUMMARY OF THE INVENTION

The current invention provides a removable set of inserts for a two-stroke engine, wherein the engine has a cylinder bore having a first bore intake cavity, a second bore intake cavity and a third bore intake cavity, and a cylinder liner having a first transfer port, a second transfer port and a central boost port such that the set of removable inserts include three inserts, a first transfer port insert configured to fit in the first bore cavity to align with the first transfer port, a second transfer port insert configured to fit in the second bore cavity to align with the second transfer port; and a third central boost port insert configured to fit in the third bore cavity to align with the central boost port. The removable set of inserts can be made of any heat resistant material such as aluminum, titanium and an alloy of aluminum and titanium. The current invention also provides for a two-stroke engine with the removable set of inserts.

The invention also provides for a two-stroke engine with a plurality of cylinder bores, wherein each cylinder bore include a first cavity, a second cavity, and a third cavity, a plurality of removable inserts, wherein a first insert fits in the first cavity, a second insert fits in the second cavity and a third insert fits in the third cavity, a cylinder liner configured to fit inside the cylinder bore so as to keep said plurality of inserts in place during operation of the engine and wherein said liner comprises a first transfer port that aligns with the first insert, a second transfer port that aligns with the second insert, a central boost port that aligns with the third insert and an exhaust port, and an exhaust system that aligns with said exhaust port. The two-stroke engine further comprises a removable insert for the exhaust system. The plurality of inserts is configured to regulate the air flow into and out of the cylinder bore. The two-stroke engine may include an engine block that is forged as a single piece of billet aluminum and can also include a puck configured to fit over the cylinder bore to hold the cylinder liner in position, a cylinder head base secured on top of the puck, a cylinder head cap secured (such as by bolting for example) on top of the cylinder head base. The two-stroke engine can further include a détente in the cylinder and a key in the cylinder liner for properly orienting the liner during assembly of the engine.

Also in accordance with the current invention, methods of assembling, tuning and regulating a two-stroke engine are provided. For example, provided is a method for assembling a two-stroke engine comprising obtaining a billet block having a plurality of cylinder bores wherein each cylinder bore comprises a first cavity, a second cavity, and a third cavity; placing a removable insert in each of the first, second and third cavity in the cylinder bore, placing a cylinder liner configured to fit inside each cylinder bore so as to keep the insert in the first, second and third cavity in place during operation of the engine wherein said liner comprises a first transfer port that aligns with the first insert; a second transfer port that aligns with the second insert and a central boost port that aligns with the third insert, placing a puck over each cylinder bore, securing the puck by a cylinder head base; and securing the cylinder head base with a cylinder head cap. The cylinder head base may further comprise a ring to prevent separation of the cylinder liner from a water jacket surrounding the cylinder bore.

In another embodiment of the invention, provided is a method for regulating the power output of a two-stroke engine comprising providing an engine block with a plurality of cylinder bores, wherein each cylinder bore comprises a first intake cavity, a second intake cavity and a third intake cavity, placing a first removable insert in the first cavity, placing a second removable insert in the second cavity, placing a third removable insert in the third cavity, providing a cylinder liner for each cylinder bore, each liner comprising a first transfer port, a second transfer port and a central boost port, placing a cylinder liner in each cylinder bore so as to keep said plurality of inserts in place during operation of the engine, wherein the first transfer port aligns with the first insert; the second transfer port aligns with the second insert and the central boost port aligns with the third insert, wherein the amount of air flow into and out of the cylinder bore is regulated by the presence of the first, second and third removable inserts.

The invention also provides for a method for altering the power output of a two-stroke engine having a first set of removable intake inserts comprising replacing said first set of removable intake inserts with a second set of removable intake inserts, wherein said second set comprises inserts with different sizes than inserts in said first set.

### BRIEF DESCRIPTION OF THE DRAWINGS

It being understood that the figures presented herein should not be deemed to limit or define the subject matter claimed herein, the applicants' invention may be understood by reference to the following description taken in conjunction with the accompanying drawings, in which:

FIG. 1A shows an exploded side view of a billet block and the associated various parts of a two-stroke engine in accordance with the current invention. FIGS. 1B and 1C are exploded views of FIG. 1A. FIG. 1D is an alternate embodiment of a block, in accordance with the current invention, with a detent and matching key in the cylinder sleeve.

FIGS. 2A and 2C are illustrations of an insert for a first transfer port according to the current invention. FIG. 2B is a sectional view along line B-B of first transfer insert. FIG. 2D is a side view of the insert of FIG. 2A along line A-A. FIG. 2E is an insert for a second transfer port according to the current invention. FIG. 2F is a sectional view along line B-B of the second transfer insert and FIG. 2G depicts another view of the insert of FIG. 2E.

FIG. 3A is an illustration of an insert for a central boost port along the right bank of a V-block. FIG. 3B is a cross-sectional view along lines 3B-3B illustrating the ridges in the insert. FIG. 3C is an insert for a central boost port along the left bank of a V-block and FIG. 3D is a sectional view along lines 3D-3D of FIG. 3C. FIGS. 3E and 3F depict perspective and front views of an alternate embodiment of an insert for a central boost port. FIG. 3G is a top view and 3H depicts a side view along lines F-F of FIG. 3F.

FIGS. 4A and 4B depict both sides of a cylinder head base with a ring in accordance with the current invention. FIGS. 4C and 4D depict opposite sides of an alternate embodiment of a cylinder head for the starboard (right side) of the engine having a ring, a ridge and a relief opening. FIGS. 4E and 4F depict opposite sides of an alternate embodiment of a cylinder head for the port (left side) of the engine having a ring, a ridge and a relief opening.

FIGS. 5A and 5B illustrate both sides of a cylinder head base without a ring in accordance with the current invention.

FIGS. 6A and 6B illustrate both sides of a cylinder head cap in accordance with the current invention.

FIG. 7A illustrates a block for a two-stroke engine with sets of exhaust inserts in accordance with the current invention. FIG. 7B depicts an exploded view of the block with the two set of exhaust inserts, a left bank exhaust insert and a right bank exhaust insert.

FIGS. 8A and 8B depict the two sides of the bottom end of an engine block in accordance with the current invention.

FIG. 9A illustrates a sectional view of an engine block in accordance with the current invention with cylinder bores and various cavities that house the intake inserts of the current invention. FIG. 9B depicts a cylinder liner (with its various intake ports and inserts) that fits into the cylinder bore in front of the inserts in the cylinder bore.

FIG. 10 A depicts an alternate embodiment of a port side (left side) cylinder sleeve in accordance with the current invention, featuring a step flange, a key and support fingers. FIG. 10B is a sectional view of the section of the sleeve highlighting the key. FIG. 10C illustrates a sleeve for the starboard (right) side of the engine, with a step flange, key and fingers. FIG. 10D is a sectional view illustrating a sleeve key.

### DESCRIPTION OF ILLUSTRATIVE EMBODIMENTS

Illustrative embodiments of the invention are described below. In the interest of clarity, not all features of an actual implementation are described in this specification. The following detailed description of exemplary embodiments, read in conjunction with the accompanying drawings, is merely illustrative and is not to be taken as limiting the scope of the invention. Rather, the scope of the invention is defined by the appended claims and equivalents thereof. It will of course be appreciated that in the development of an actual embodiment, numerous implementation-specific decisions must be made to achieve the design-specific goals, which will vary from one implementation to another. Moreover, it will be appreciated that such a development effort, while possibly complex and time-consuming, would nevertheless be a routine undertaking for persons of ordinary skill in the art having the benefit of this disclosure. Further aspects and advantages of the various embodiments of the invention will become apparent from consideration of the following description and drawings. It is noted, however, that the figures are not necessarily drawn to scale.

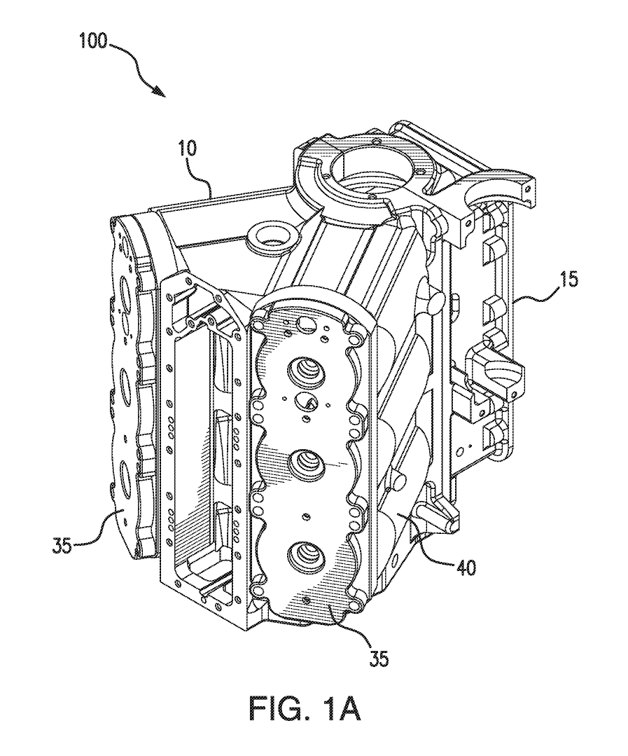

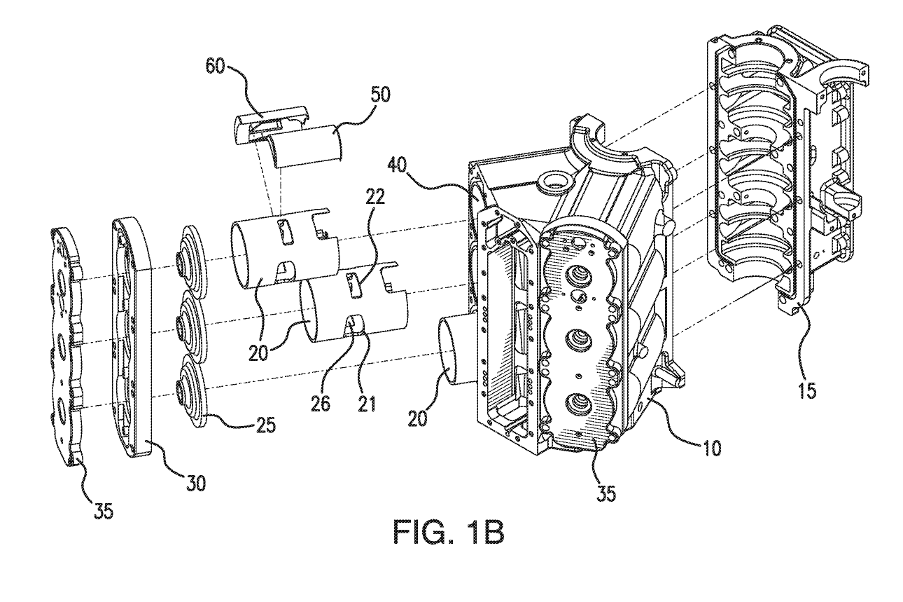

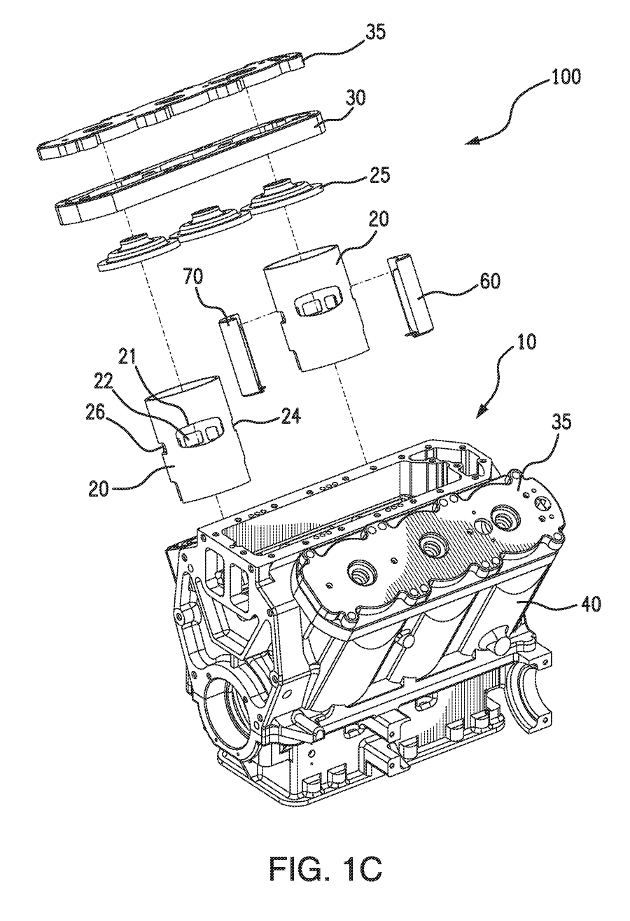

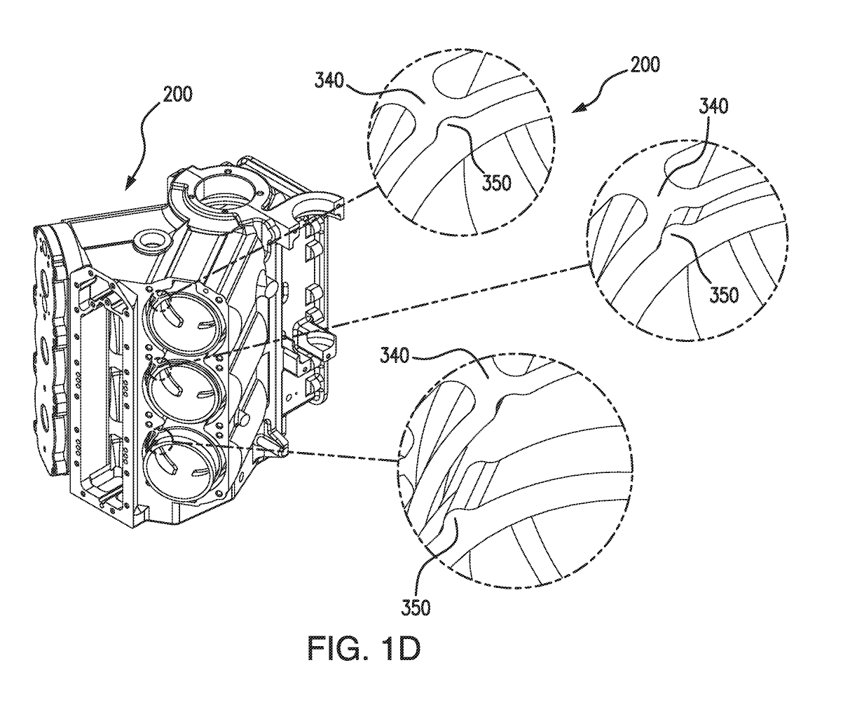

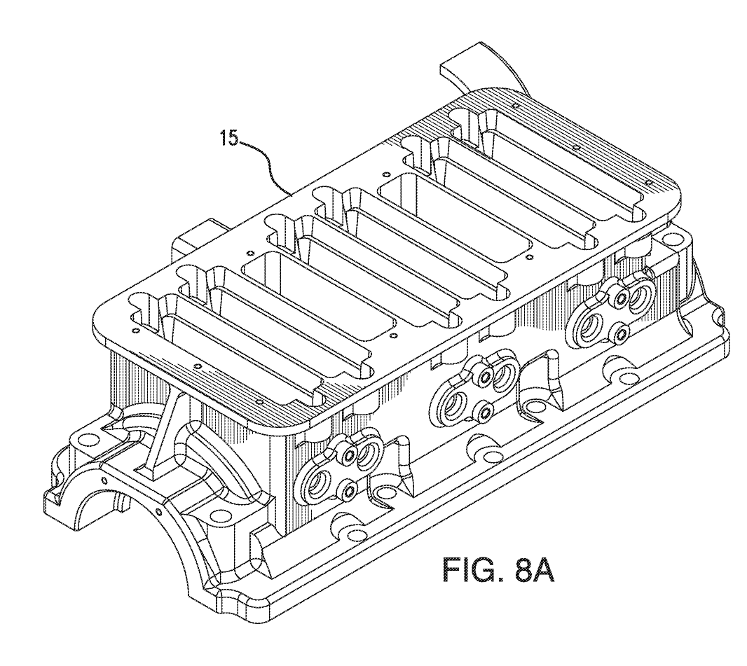

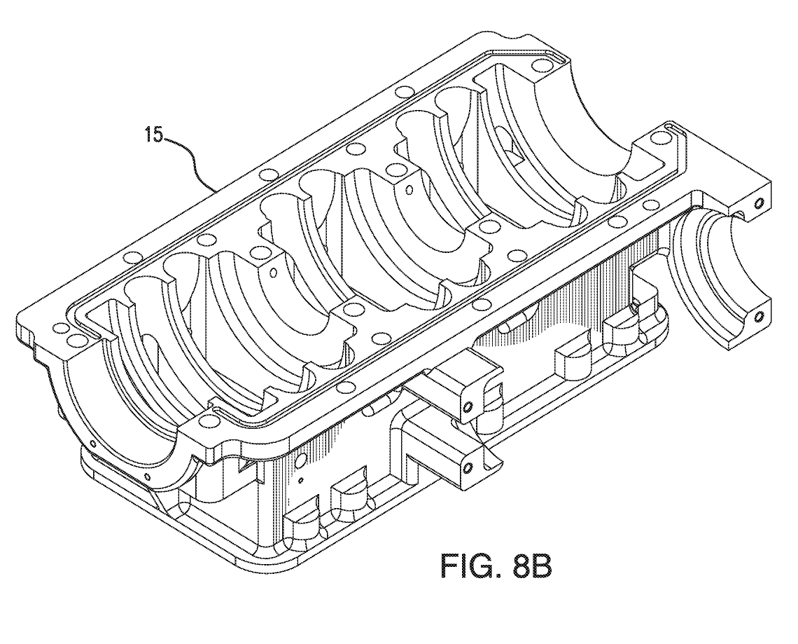

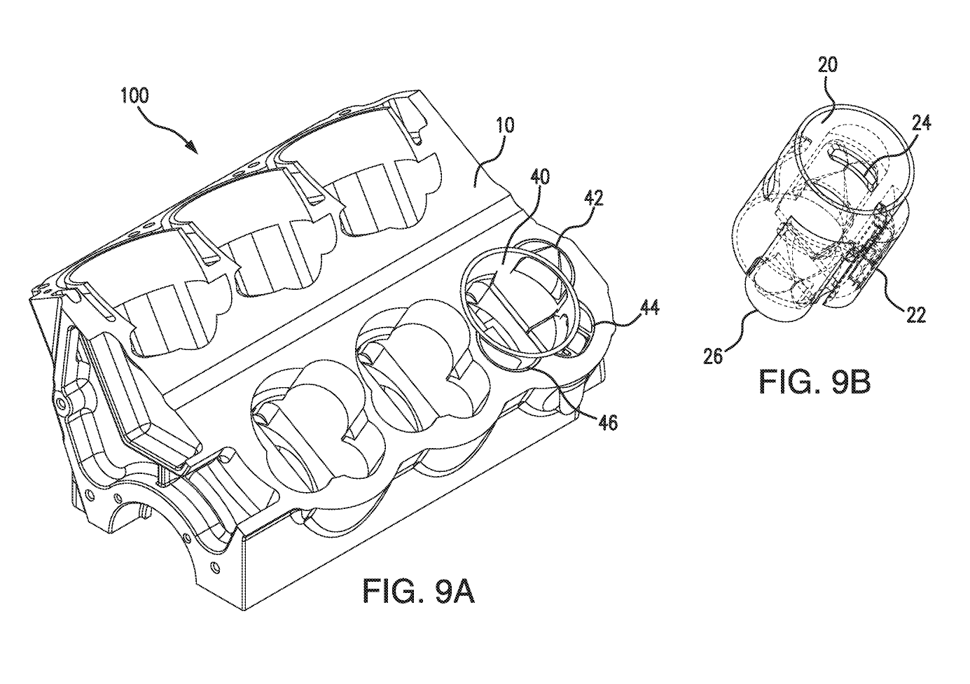

Embodiments of the present disclosure provide for a two-stroke engine as shown in FIGS. 1A, 1B, 1C, 1D, 9A and 9B. Engine 100 has block bottom end 15 (also shown in FIGS. 8A and 8B), block 10, cylinder bore 40, cylinder liner 20, a plurality of pucks 25, cylinder head base 30 and cylinder head cap 35. Cylinder liner 20, also referred to as cylinder sleeve, has exhaust port 21, central boost port 22, first transfer port 24, and second transfer port 26 (also shown in FIG. 9B). As known by those of skill in the art, central boost port is composed of three sections, two finger ports on either side of a boost port. Engine 100 is shown as a V six-cylinder engine. However, the current invention applies to engines having any number of cylinders. Cylinder bore 40 includes cavities 42, 44 and 46 (as shown in 9A), which receive inserts 50, 60 and 70. Intake cavities 42, 44, and 46 are bored into the cylinder near the bottom part, closest to block bottom end 15. When building an engine, three intake cavities are bore first, then one insert is placed in each cavity. Cavity 42 receives the insert 60 for first transfer port 24. Cavity 44 receives insert 50 for center boost port 22 and cavity 46 receives insert 70 for second transfer port 26. Cylinder liner 20 is placed in the cylinder bore 40 and pushed down until it presses against inserts 50, 60, and 70, such that center boost port 22 of cylinder 20 aligns with insert 50 in cavity 44. Similarly first transfer port 24 aligns with insert 60 in cavity 42 and second transfer port 26 aligns with insert 70 cavity 46. Cylinder liner 20 keeps all inserts in position with the cavities.

FIG. 1D illustrates an alternate embodiment of an engine block in which the cylinders have a détente 340 to receive a counterpart sleeve key 350. Both the detent and key help in properly orienting the cylinder sleeve or liner in the cylinder and block. They also prevent the sleeve from rotating in the block.

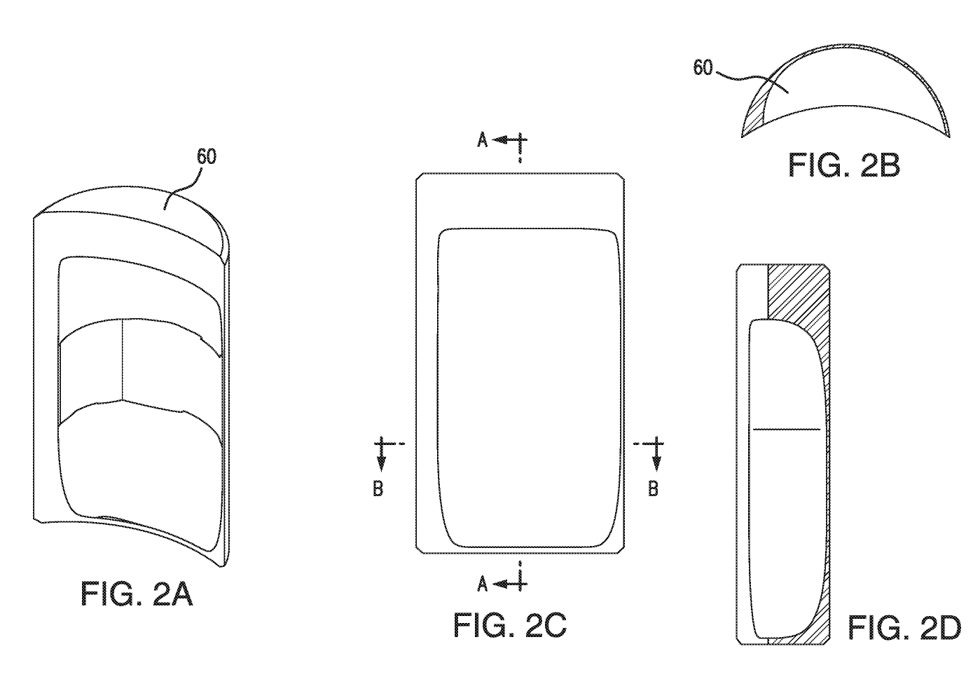

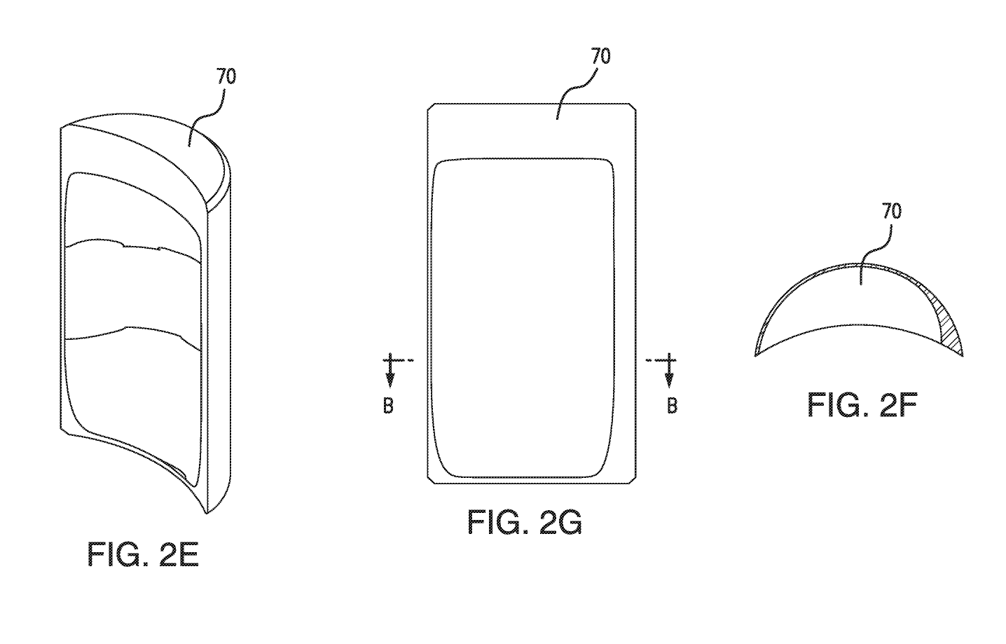

FIG. 2A shows insert 60 for first transfer port. The insert has a cross-sectional shape, along line B-B, shown in FIG. 2B. Minor variations in the design and shape are also within the scope of the current invention. For example, the side of insert 60 that flanks or is closest to the exhaust port 21 on liner 20 may be deeper that the side flanking center boost port 22. Insert 60 regulates air flow through the first transfer port 24 (also referred to as upper transfer port) in liner 20. Adjusting the cross sectional area, when tuning the engine to either decrease or increase the air flow through the first transfer port is within the scope of the invention. Insert 60 has front and side views and design as illustrated in FIGS. 2C and 2D.

Insert 70 that aligns with second transfer port 26 (also referred to as bottom transfer port) on cylinder liner 20 is shown in FIGS. 2C and 2D. Insert 70 has a similar shape and function to insert 60 discussed supra. The cross sectional shape, along line D-D, is shown in FIG. 2D. As for insert 70, a person of skill in the art realizes that changes in the design are possible so as to control and finely regulate the amount of air through second transfer port 26. A person of skill in the art appreciates that carefully shaped and positioned transfer ports and associated intake inserts help direct the flow of new fuel mixture toward the combustion chamber as it enters the cylinder. Insert 70 has a side view and design as illustrated in FIG. 2G.

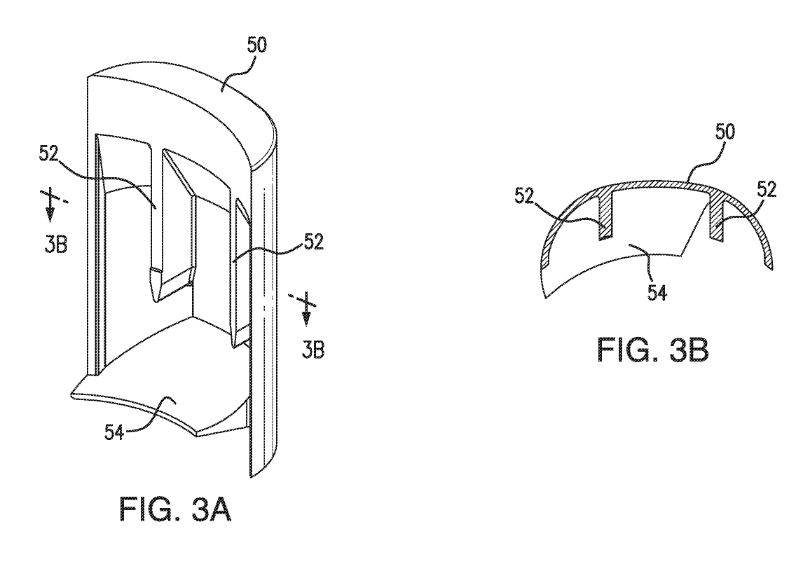

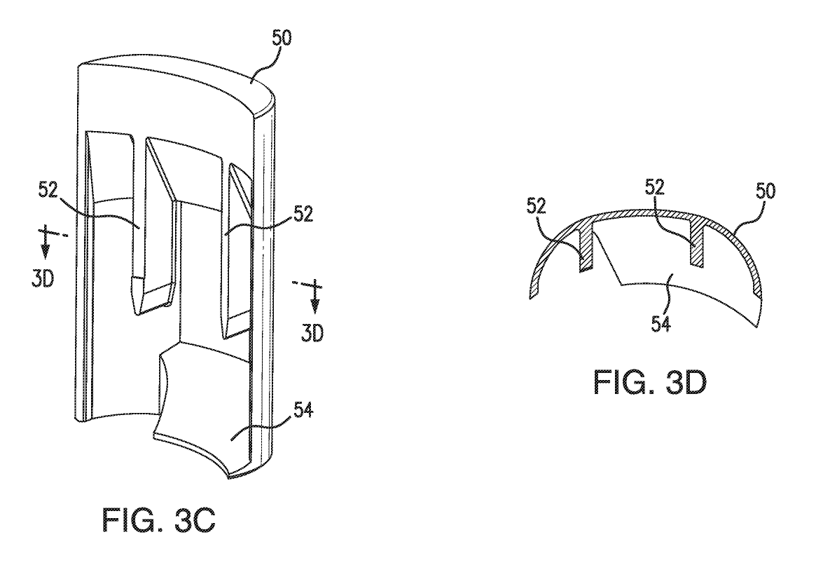

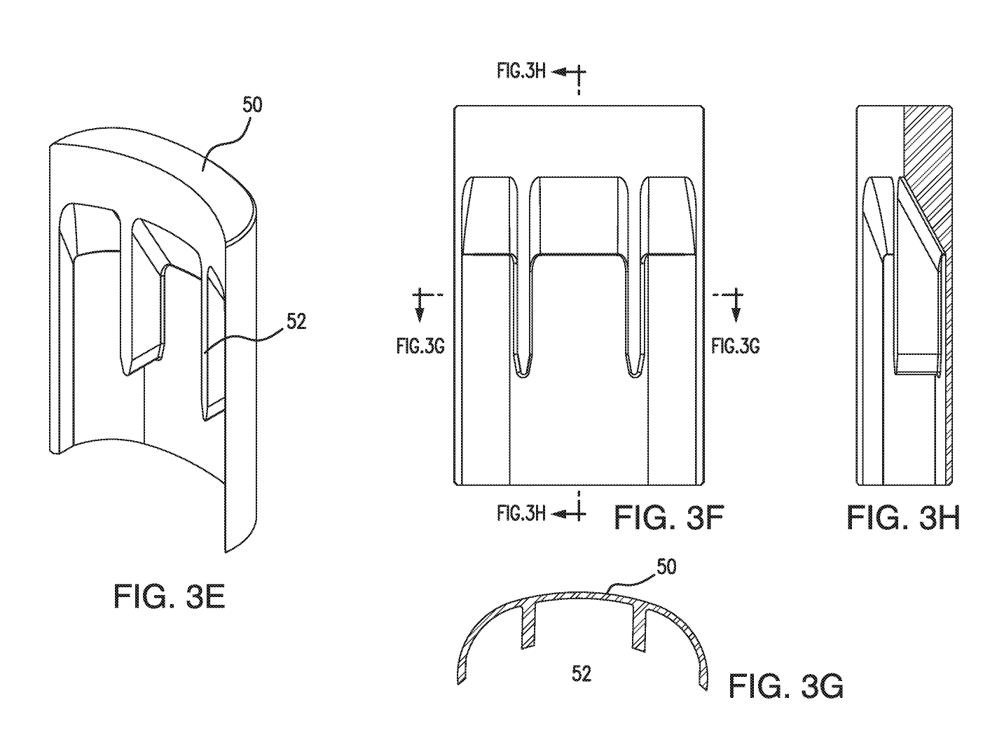

FIGS. 3A-3D illustrate removable insert 50 which is positioned in the engine in intake cavity 44 in cylinder bore 40. Insert 50 regulates air flow through center boost port 22 of cylinder liner 20. FIGS. 3A and 3C depict mirror images of insert 50 that are used in cylinders located on either the left or right bank of the engine. Insert 50 has base 54 and ridges 52 that fit in the two finger ports that flank the center boost window of port 22. FIG. 3B shows a cross-sectional part taken along line 3B-3B of FIG. 3A. Similarly, FIG. 3D shows a cross-sectional part taken along line 3D-3D of FIG. 3A. An alternate embodiment of a removable insert 50 is depicted in FIGS. 3E-3H. In this embodiment, insert 50 lacks base 54.

The insert for the central boost system is molded to fit the two finger port and the central boost channels. The function of the boost channel to enhance air flow is known in the art. Finger ports supercharge the air around the boost port and are located lower than the boost port at 5 degrees of separation corresponding to rotation in the crankshaft.

Inserts 50, 60 and 70 are made of heat resistant material such as aluminum, titanium or an alloy of both. Other suitable material are also within the scope of the invention as realized by those of skill in the art. Inserts 50, 60 and 70 are easy to remove and replace with newer inserts during tuning or repair of the engine.

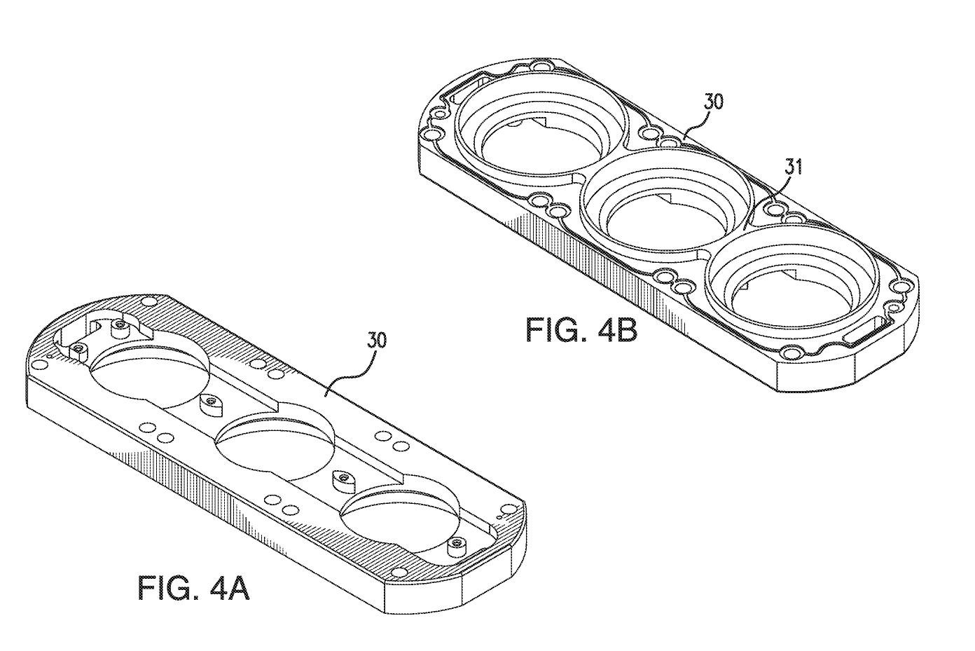

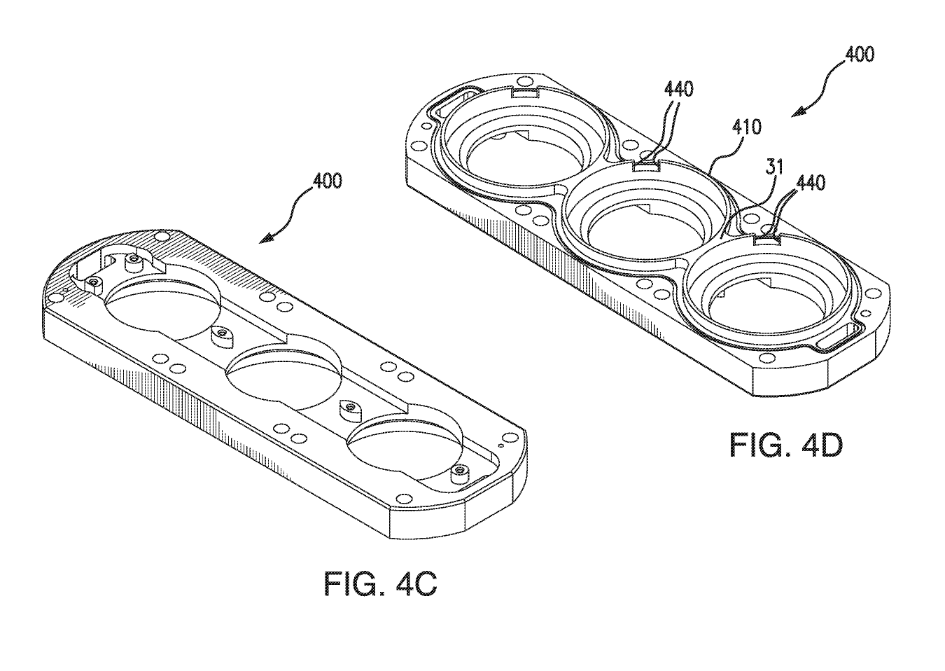

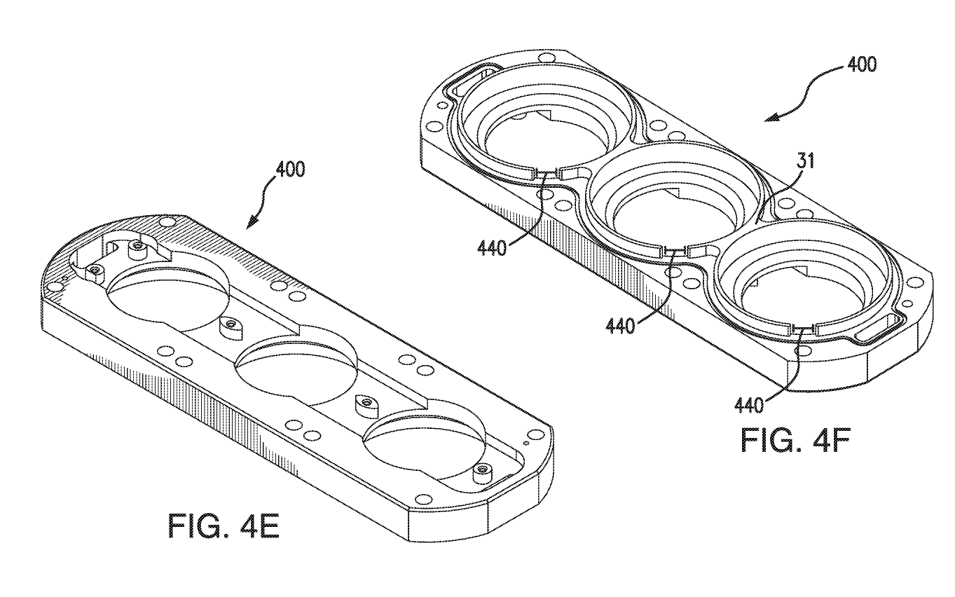

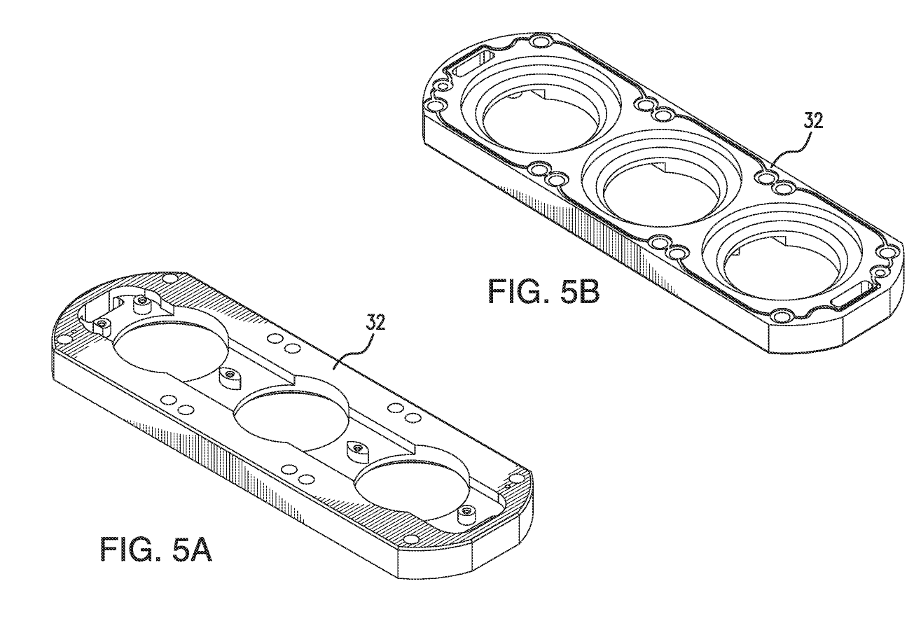

In accordance with the current invention, engine 100 is provided with block 10 forged as single aluminum billet block and having a unique design comprising a cylinder head base as shown FIGS. 4A, 4B, 5A and 5B. The cylinder head base 30 can be designed with ring 31 or without 32. Ring 31 helps keep cylinder liner 20 in place and prevents it from separating from water jacket (not shown) so as to prevent water from entering into the cylinder bore. The cylinder pucks holds the liner and water jacket in position.

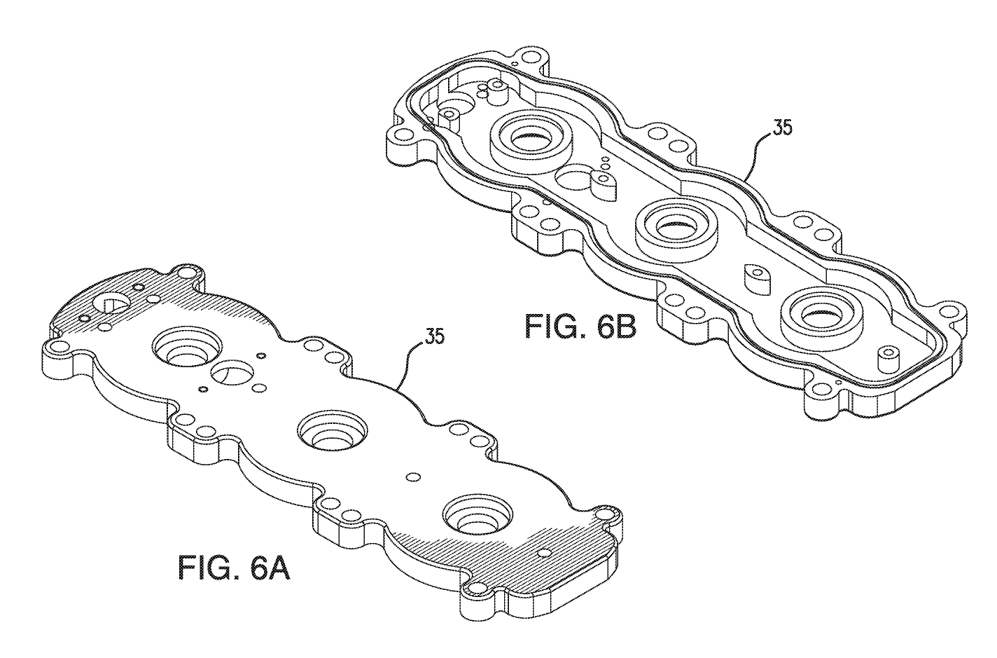

FIGS. 4A and 4B show the top and bottom side respectively of base 30 having ring 31. The bottom side is the side that faces and secures pucks 25 in position as illustrated in FIGS. 1B and 1C. FIGS. 5A and 5B depict the top and bottom side respectively of an embodiment of a cylinder head base 32 that does not include a ring. Cylinder head bases 30 and 32 can both be used in conjunction with cylinder head cap 35 illustrated in FIGS. 6A and 6B. FIGS. 4C and 4D show the top and bottom side respectively of an alternate embodiment of a cylinder head base with a ring 400 having a ridge (also referred to as a flange) 410, relief opening 440 that is used for the starboard side of the engine. FIGS. 4E and 4F show the top and bottom side respectively of an alternate embodiment of a cylinder head base with a ring 400 having a ridge 410, relief opening 440 that is used for the port (left) side of the engine. Ridge 410 is a form of support for sleeve 300 that aligns with detent 310 and key 350 (shown in FIG. 1D) on the cylinder. Ridge 410 prevents the separation between sleeve 300 and the water jacket (not shown of the block). Ridge 410 mates with top inside of the water jacket, sleeve and block and squeezes top of the water jacket with a low compression fit. This fit prevents any movement of the sleeve or water jacket during the running of the motor.

The upper side of the cylinder head base receives cylinder head cap 35 illustrated in FIGS. 6A and 6B. FIG. 6A depicts the top side of cap 35. FIG. 6B shows the bottom side which secures over cylinder head bases 30 or 32 also as shown in FIGS. 1B and 1C.

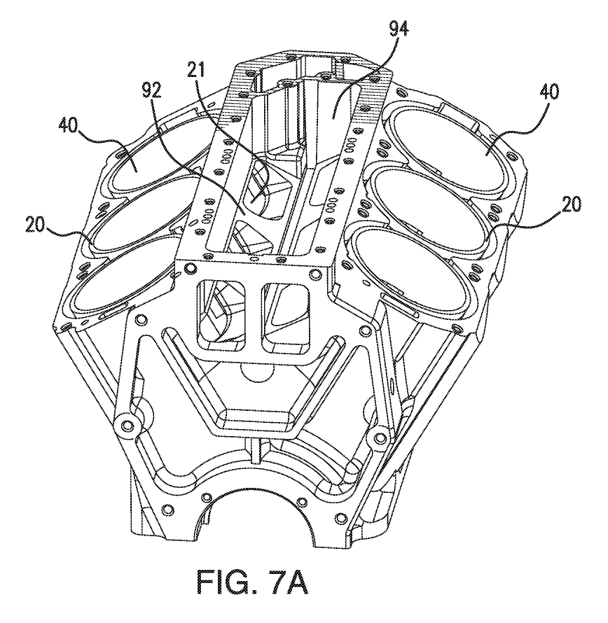

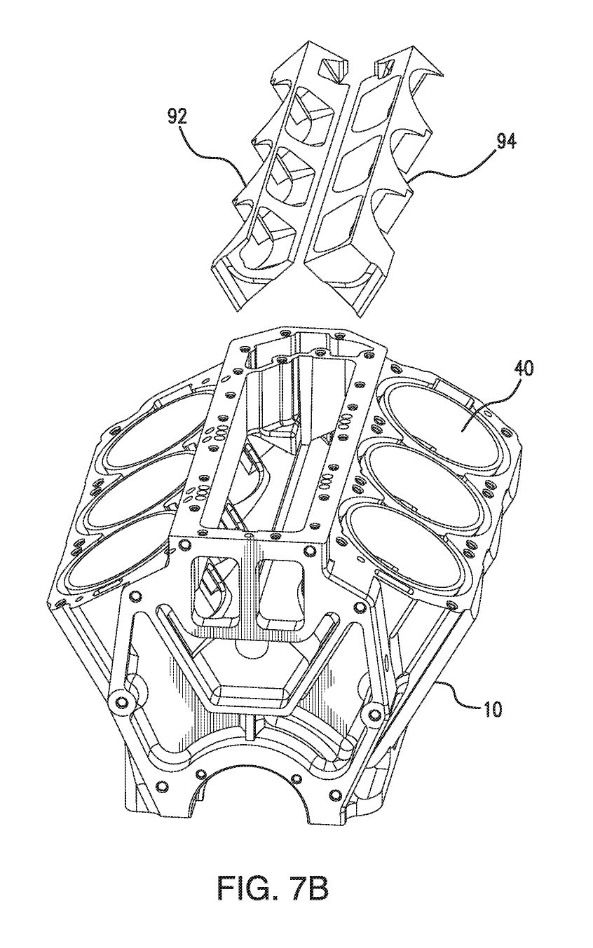

Removable inserts for the exhaust system of a two-stroke engines are also in accordance with the current invention. They help, in association with the intake inserts 50, 60 and 70, to finely tune engine 100 and regulate air/fuel flow within the engine's cylinders. Exhaust inserts 92 and 94, as shown in FIGS. 7A and 7B, are in sets of three corresponding to the left and right banks of the exhaust system of the engine. however, as appreciated by those of skill in the art, exhaust inserts can also be designed as individual inserts.

The use of intake inserts 50, 60 and 70 in a two-stroke engine, in accordance with the current invention, has significant advantages. For example, it cuts down tremendously on the time and steps taken for engine assembly, tuning, maintenance or repair. Tuning, an engine in accordance with the current invention, can be done in a fraction of the time needed for prior art engines. The intake inserts are removable and replaceable. Their use omits the need to machine the inside of the cylinder during. In addition the same engine block can be used in connection with various size and shapes of intake inserts so as to build engines with varying energy output and horsepower. The current invention provides the ability to alter (reduce or increase) the horsepower of the same engine and block by altering the size or dimensions of the inserts. The current intake inserts may be used in association with several types of two-stroke engines including those with direct injection of oil/gas fuel mixture. Another advantage for the use of the intake inserts in accordance with the current invention besides is that the easier tunability that they afford an engine allows for a more efficient and cleaner fuel burning thereby resulting in less emission of pollutants.

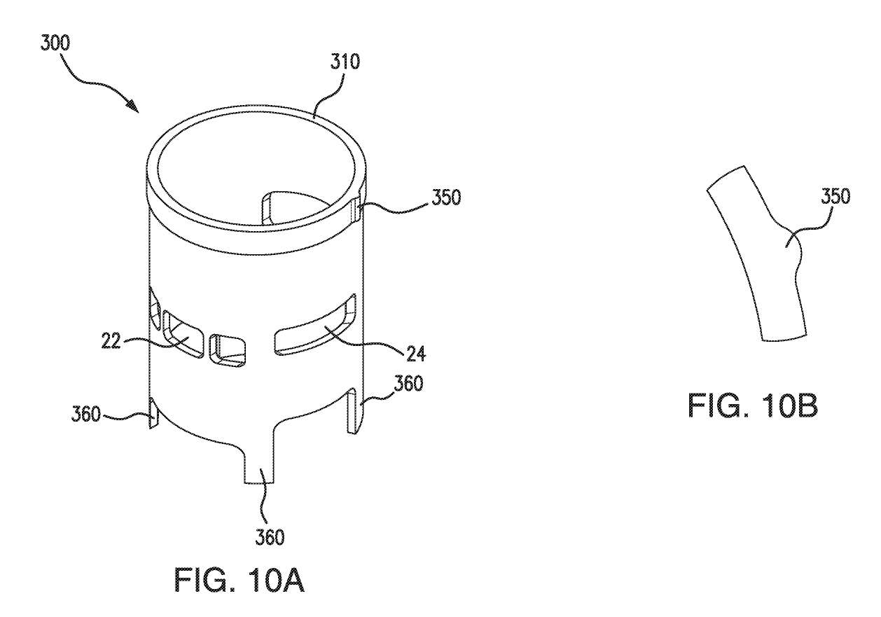

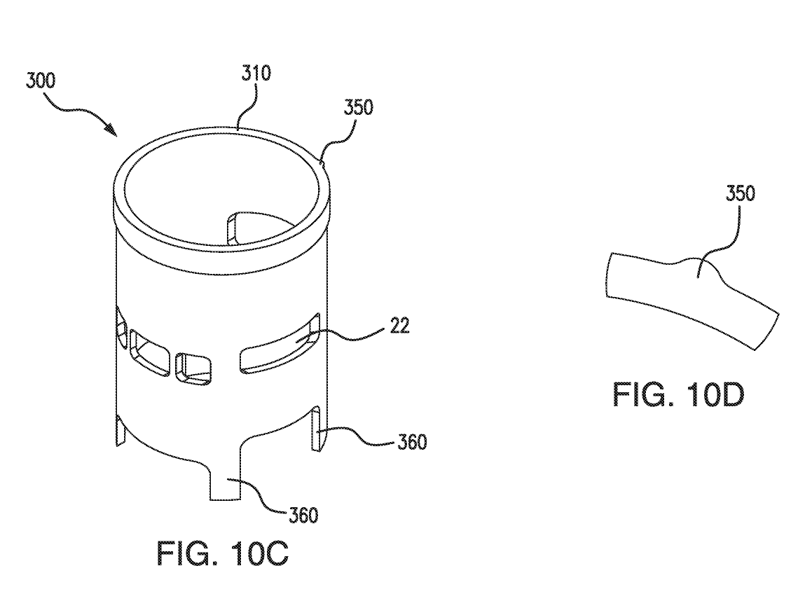

FIGS. 10A and 10B illustrate an alternate embodiment for a cylinder sleeve or liner 300. Sleeve 300 includes step flange 310, key 350 and support fingers 360. The key 350 fits into detent 340 of the cylinder (shown in FIG. 1D). The key and detent help prevent the sleeve from rotating in the block and present a guide for proper axial orientation during assembly.

Also in accordance with the current invention, methods of assembling, tuning and regulating a two-stroke engine are provided. For example, provided is a method for assembling a two-stroke engine comprising obtaining a billet block having a plurality of cylinder bores wherein each cylinder bore comprises a first cavity, a second cavity, and a third cavity; placing a removable insert in each of the first, second and third cavity in the cylinder bore, placing a cylinder liner configured to fit inside the cylinder bore so as to keep the insert in the first, second and third cavity in place during operation of the engine wherein said liner comprises a first transfer port that aligns with the first insert; a second transfer port that aligns with the second insert and a central boost port that aligns with the third insert, placing a puck over each cylinder bore, securing the puck by a cylinder head base; and securing the cylinder head base with a cylinder head cap. The cylinder head base may further comprise a ring to prevent separation of the cylinder liner from a water jacket surrounding the cylinder bore.

In another embodiment of the invention, provided is a method for regulating the power output of a two-stroke engine comprising providing an engine block with a plurality of cylinder bores, wherein each cylinder bore comprises a first intake cavity; a second intake cavity and a third intake cavity, placing a first removable insert in the first cavity, placing a second removable insert in the second cavity, placing a third removable insert in the third cavity, providing a cylinder liner comprising a first transfer port, a second transfer port and a central boost port, placing the cylinder liner in the cylinder bore so as to keep said plurality of inserts in place during operation of the engine, wherein the first transfer port aligns with the first insert; the second transfer port aligns with the second insert and the central boost port aligns with the third insert, wherein the amount of air flow into and out of the cylinder bore is regulated by the presence of the first, second and third removable inserts.

The invention also provides for a method for altering the power output of a two-stroke engine having a first set of removable intake inserts comprising replacing said first set of removable intake inserts with a second set of removable intake inserts, wherein said second set comprises inserts with different sizes than inserts in said first set. In another embodiment, the method for altering the power output of a two-stroke engine, comprises replacing exhaust inserts 92 and/or 94.

It will be understood by one of ordinary skill in the art that in general any subset or all of the various embodiments and inventive features described herein may be combined, notwithstanding the fact that the claims set forth only a limited number of such combinations.

What is claimed is:

1. A removable set of inserts for a two-stroke engine, the engine comprising:
a cylinder bore having a first bore cavity, a second bore cavity and a third bore cavity; and
a cylinder liner having a first transfer port, a second transfer port and a central boost port,
wherein the set of removable inserts comprises:
a first transfer port insert configured to fit in the first bore cavity to align with the first transfer port;
a second transfer port insert configured to fit in the second bore cavity to align with the second transfer port; and
a third central boost port insert configured to fit in the third bore cavity to align with the central boost port.

2. The removable set of inserts of claim 1, wherein the inserts are made of a material selected from the group consisting of aluminum, titanium and an alloy of aluminum and titanium.

3. A two-stroke engine comprising the removable set of inserts of claim 1.

4. A two-stroke engine comprising:
a plurality of cylinder bores, wherein each cylinder bore comprises a first cavity, a second cavity, and a third cavity;
a plurality of removable inserts, wherein a first insert fits in said first cavity, a second insert fits in said second cavity and a third insert fits in said third cavity;
a cylinder liner configured to fit inside the cylinder bore so as to keep said plurality of inserts in place during operation of the engine and wherein said liner comprises a first transfer port that aligns with the first insert, a second transfer port that aligns with the second insert, a central boost port that aligns with the third insert and an exhaust port; and
an exhaust system that aligns with said exhaust port.

5. The two-stroke engine of claim 4, further comprising a removable insert for the exhaust system.

6. The two-stroke engine of claim 4, wherein said plurality of inserts regulate the air flow into and out of the cylinder bore.

7. The two-stroke engine of claim 4, wherein the plurality of removable inserts are made of a material selected from the group consisting of aluminum, titanium and an alloy of aluminum and titanium.

8. The two-stroke engine of claim 4, further comprising an engine block that houses the plurality of cylinder bores, wherein said engine block is forged as a single piece.

9. The two-stroke engine of claim 4, further comprising a détente in the cylinder and a key in the cylinder liner for properly orienting the liner during assembly of the engine.

10. The two-stroke engine of claim 7, wherein the engine block is made of billet aluminum.

11. The two-stroke engine of claim 4, further comprising:
a puck configured to fit over the cylinder bore to hold the cylinder liner in position;
a cylinder head base secured on top of the puck; and
a cylinder head cap secured on top of the cylinder head base.

12. A method for assembling a two-stroke engine comprising:
obtaining a billet block having a plurality of cylinder bores wherein each cylinder bore comprises a first cavity, a second cavity, and a third cavity;
placing a removable insert in each of the first, second and third cavity in the cylinder bore;
placing a cylinder liner configured to fit inside each cylinder bore so as to keep the insert in the first, second and third cavity in place during operation of the engine wherein said liner comprises a first transfer port that aligns with the first insert; a second transfer port that aligns with the second insert and a central boost port that aligns with the third insert;
placing a puck over each cylinder bore;
securing the puck by a cylinder head base; and
securing the cylinder head base with a cylinder head cap.

13. The method of claim 12, wherein the cylinder head base is bolted to the cylinder head cap.

14. The method of claim 12, wherein the cylinder head base comprises a ring to prevent separation of the cylinder liner from a water jacket surrounding the cylinder bore.

15. The method of claim 12, wherein the inserts are made of a material selected from the group consisting of aluminum, titanium and an alloy of aluminum and titanium.

16. A method for regulating the power output of a two-stroke engine comprising:
providing an engine block with a plurality of cylinder bores, wherein each cylinder bore comprises a first cavity; a second cavity and a third cavity;
placing a first removable insert in the first cavity;
placing a second removable insert in the second cavity;
placing a third removable insert in the third cavity,
providing a cylinder liner for each cylinder bore, each liner comprising a first transfer port, a second transfer port and a central boost port,
placing a cylinder liner in each cylinder bore so as to keep said plurality of inserts in place during operation of the engine, wherein the first transfer port aligns with the first insert; the second transfer port aligns with the second insert and the central boost port aligns with the third insert, wherein the amount of air flow into and out of the cylinder bore is regulated by the presence of the first, second and third removable inserts.

17. A method for altering the power output of a two-stroke engine having a first set of removable intake inserts comprising:
replacing said first set of removable intake inserts with a second set of removable intake inserts, wherein said second set comprises inserts with different sizes than inserts in said first set.
